(19) United States
(12) Patent Application Publication
(10) Pub. No.: US 2010/0229694 A1
(43) Pub. Date: Sep. 16, 2010

(54) RATCHET TOOL

(75) Inventor: Tai-Hung CHEN, Fu Hsing Hsiang (TW)

Correspondence Address: BACON & THOMAS, PLLC, 625 SLATERS LANE, FOURTH FLOOR, ALEXANDRIA, VA, 22314-1176, US

(73) Assignee: Infar Industrial Co., Ltd.

(21) Appl. No.: 12/402,692

(22) Filed: Mar. 12, 2009

(51) Int. Cl. B25B 13/46; B25B 23/00

(52) U.S. Cl. 81/63.1; 81/438

(57) ABSTRACT

A ratchet tool comprises a handle; a base body; first and second pivotal elements provided at the base body; a barrel member coupled to the base body and having teeth formed on the outer periphery thereof; a ratchet driving means including first and second pawl members pivotally connected to the base body and selectively engaged with the barrel member and an elastic section provided between the first and second pawl members, with the elastic section adapted for engaging the first and second pawl members with the barrel member; and a switch member pivotally coupled to the outer periphery of the base body for selectively switching the first and second pawl members to engage with the barrel member or not.

### BACKGROUND OF THE INVENTION

1. Field of the Invention

The present invention relates to a ratchet tool for a screwdriver.

2. Description of the Related Art

A ratchet tool for connecting to a bit, generally known as a screwdriver to loosen/tighten a fastener, includes two pawls connected to each other via a spring and operated to engage with teeth of gear selectively. However, the pawls are easy to push and wear the inner wall of the ratchet tool and the spring between the pawls could reach elastic fatigue through long or heavy use. The present invention is, therefore, intended to obviate or at least alleviate the problems encountered in the prior art.

### SUMMARY OF THE INVENTION

According to the present invention, a ratchet tool used as a screwdriver, the ratchet tool includes a handle, a base body, a barrel member for connecting to a bit, a ratchet driving means and a switch means. The switch means is moveable between first, second and third positions, and the ratchet driving means is selectively engaged with teeth of the barrel member so that while the base body is driven to rotate, the barrel member is selectively driven to rotate with the base body or not.

It is an aspect of the present invention that the base body includes a restricting portion having first, second and third recesses wherein the switch means is able to be positioned in one of the first, second and third recesses.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

FIG. 1 is a perspective view of a ratchet tool in accordance with the first embodiment of the present invention.

FIG. 2 is an exploded perspective view of the ratchet tool shown in FIG. 1.

FIG. 3 is another exploded perspective view of the ratchet tool shown in FIG. 1.

FIG. 4 is a partial, cross-sectional view of the ratchet tool shown in FIG. 1.

FIG. 5 is a cross-sectional view taken along line 5-5 of FIG. 4.

FIG. 6 is another cross-sectional view similar to FIG. 5, illustrating the switch means being in the second position.

FIG. 7 is another cross-sectional view similar to FIG. 6, illustrating that while the base body rotates counterclockwise, the second pawl member is detached from the barrel member.

FIG. 8 is another cross-sectional view similar to FIG. 6, illustrating the switch means being in the third position.

FIG. 9 is another cross-sectional view similar to FIG. 8, illustrating that while the base body rotates clockwise, the first pawl member is detached from the barrel member.

FIG. 10 is a cross-sectional view of a ratchet tool in accordance with the second embodiment of the present invention.

### DETAILED DESCRIPTION OF THE PREFERRED EMBODIMENT

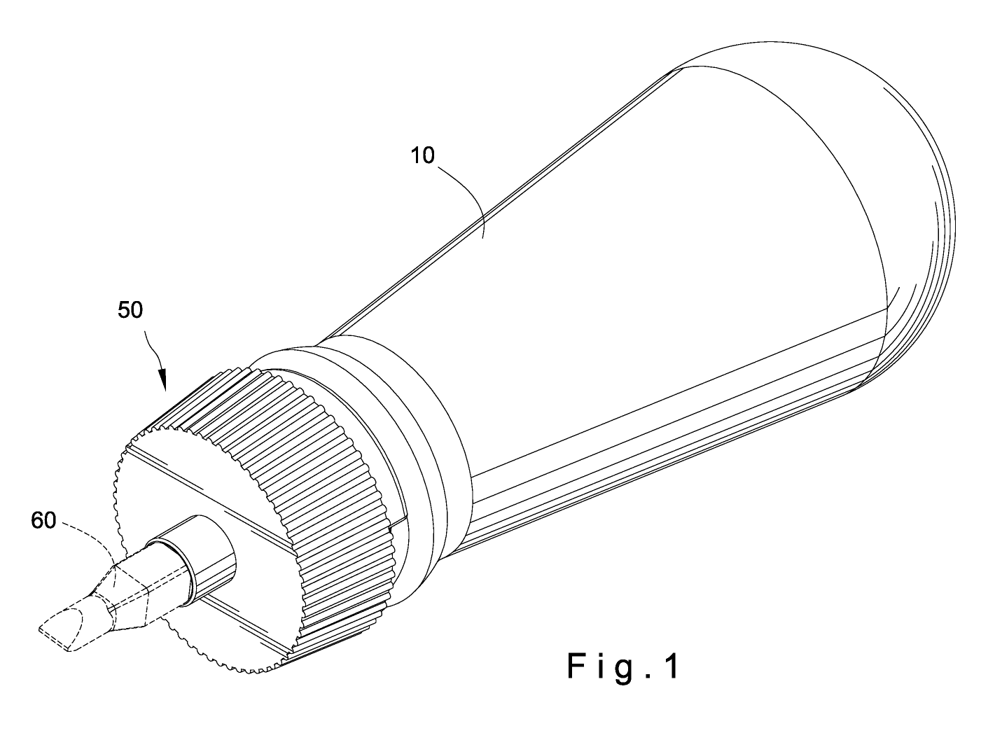

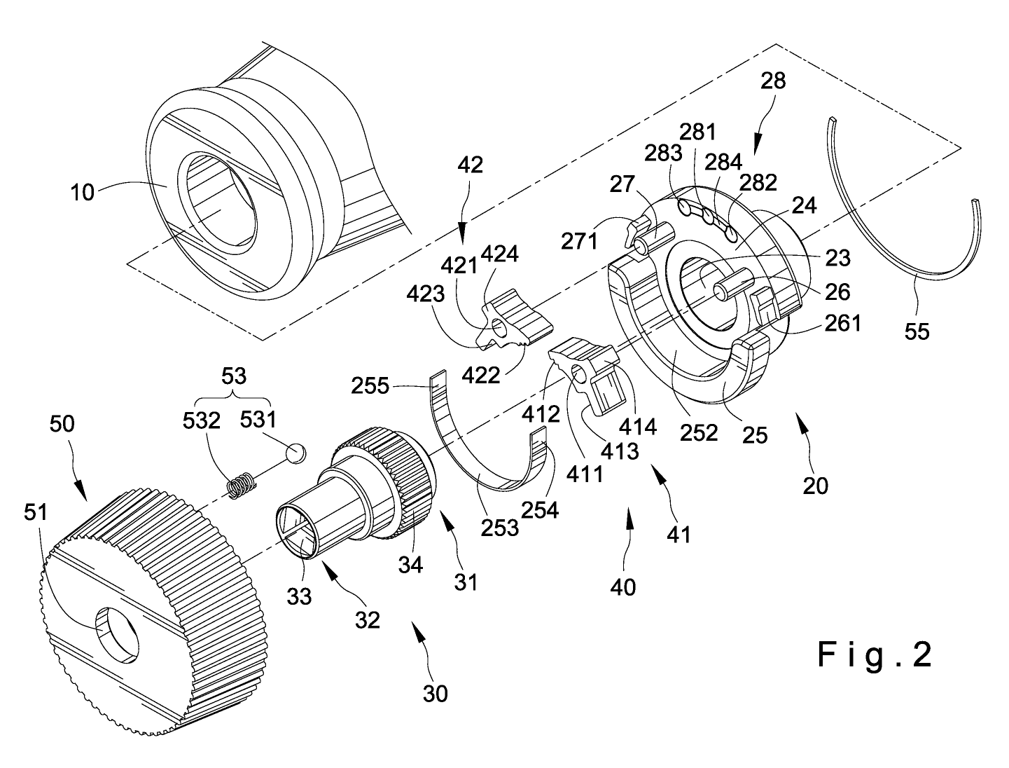

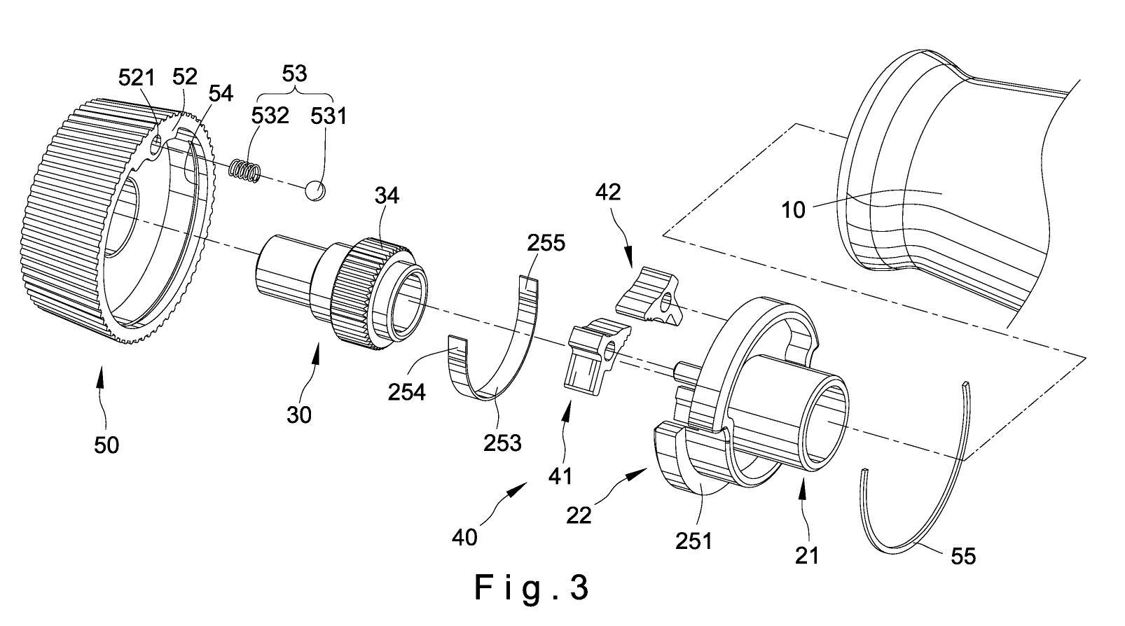

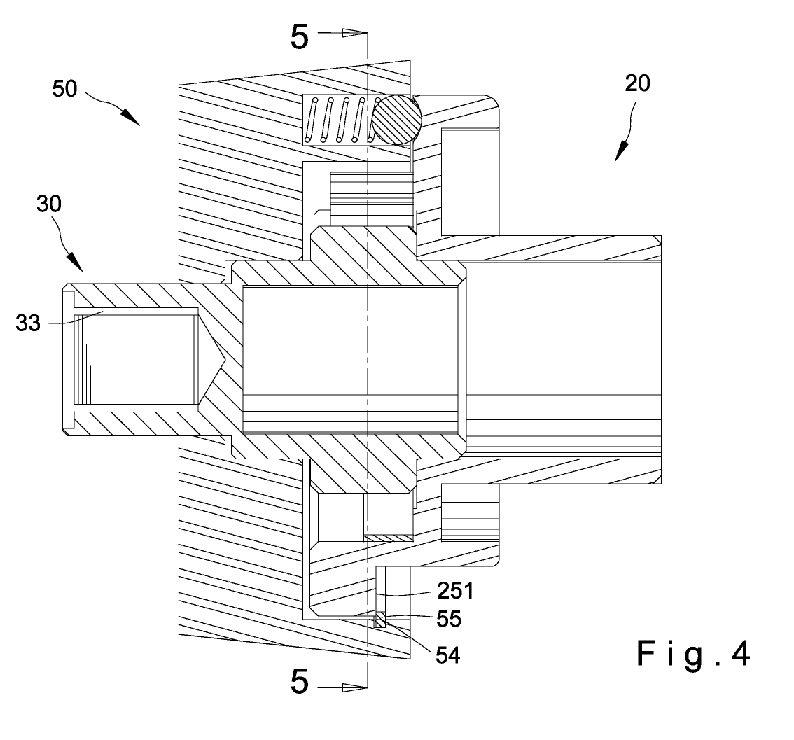

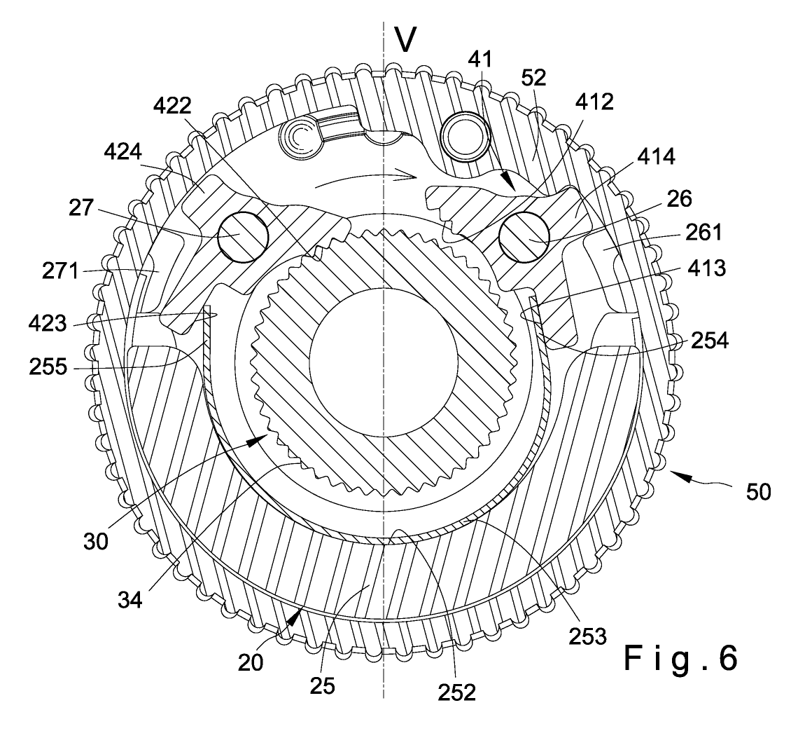

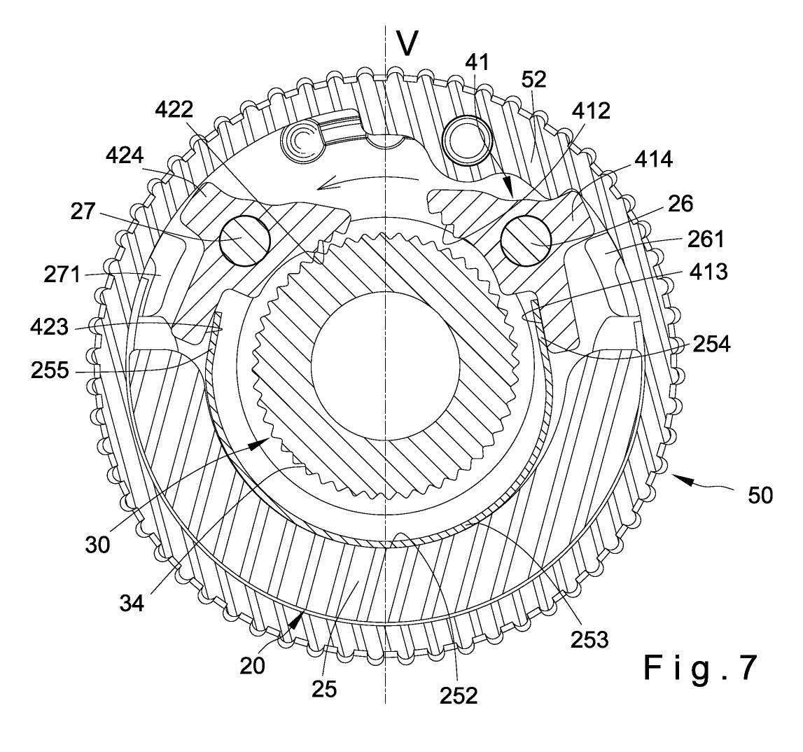

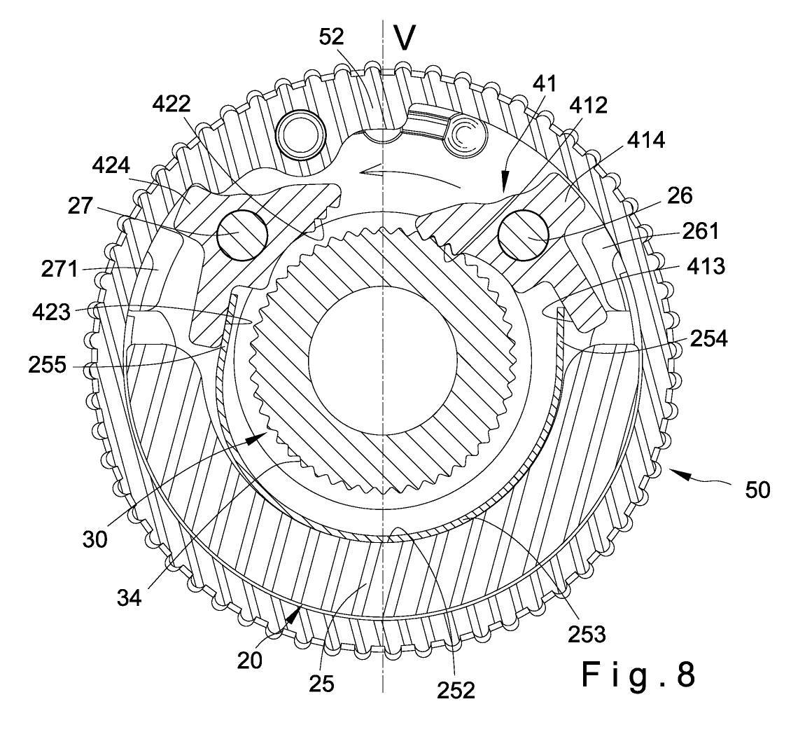

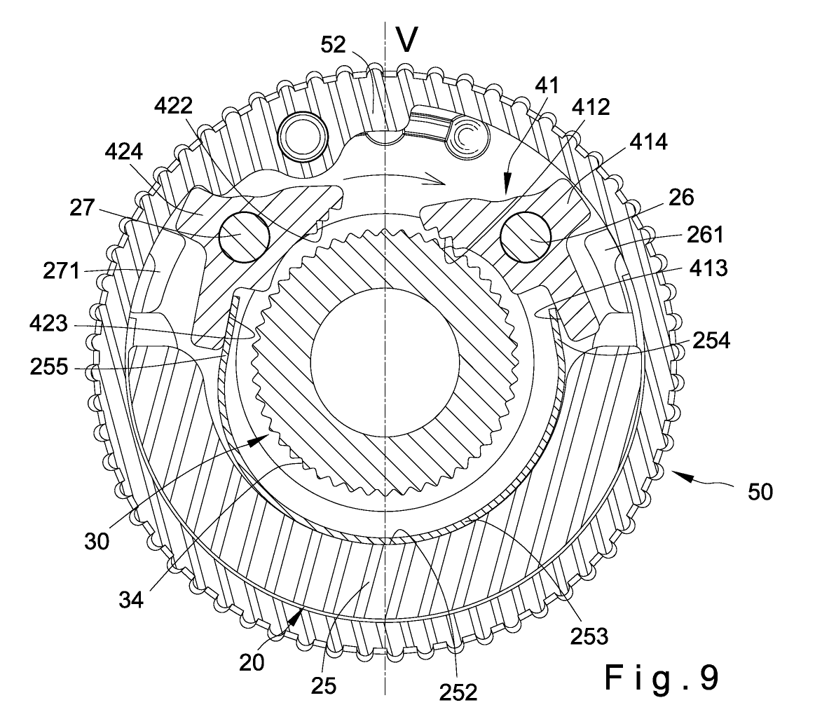

FIGS. 1 through 9 show a ratchet tool usable for loosening/tightening a fastener as a screwdriver in accordance with the preferred embodiment of the present invention. The ratchet tool includes a handle 10 for gripped by a user, a base body 20 installed to a front end of the handle 10, a barrel member 30 pivotally coupled to the base body 20, a ratchet driving means 40 installed to the base body 20 and switchably engaged with the barrel member 30 and a switch means 50 adapted to control an engagement status between the ratchet driving means 40 and the barrel member 30.

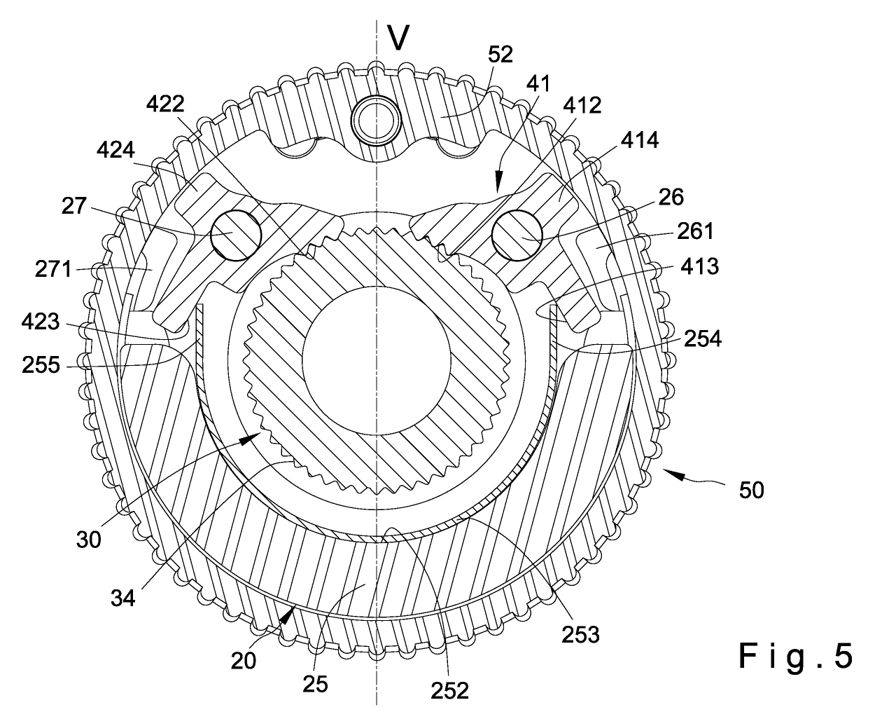

The base body 20 includes a first end 21 coupled to the front end of the handle 10 and a second end 22 against the barrel member 30 and the ratchet driving means 40. A through-hole 23 which is axially formed on and pierces the base body 20 is adapted to couple to the barrel member 30. A receptacle portion 24 is formed on the periphery of the second end 22 for receiving the ratchet driving means 40 and an arcuate projection 25 is provided on a side of the receptacle portion 24. A fictitious dotted or dashed line V as shown in FIGS. 5 through 9 is provided to divide the projection 25 into two symmetrical parts in accordance therewith. The projection 25 includes a flange 251 toward the first end 21 and an arcuate receiving portion 252 formed at the inner periphery thereof against the second end 22. An elastic section 253 is in form of a U-shaped flat piece and has first and second resilient ends 254, 255 defined at two ends thereof. Parts of the elastic section 253 between the first and second resilient ends 254, 255 correspond and are received in the receiving portion 252 of the projection 25.

First and second pivotal elements 26, 27 are set on the other side of the receptacle portion 24 opposite to the projection 25 and symmetrical to each other in accordance with the dotted line V. First and second limited portions 261, 271 are respectively disposed between the first and second pivotal elements 26, 27 and two distal ends of the projection 25.

A restricting portion 28, which is defined along the periphery of the receptacle portion 24 opposite to the receiving portion 252 and provided between the first and second pivotal elements 26, 27, includes an arcuate rail 284 opposite to the projection 25 and first, second and third recesses 281, 282 and 283 formed on the rail 284 and equally spaced from one another. The first recess 281 intermediates the second and third recesses 282, 283 and is defined at the dotted line V. Therefore, distance between the second recess 282 and the dotted line V is equal to that between the third recess 283 and the dotted line V.

First and second ends 31, 32 are defined at two ends of the barrel member 30. The first end 31 is pivotally connected to the through-hole 23 of the base body 20 so that the barrel member 30 is able to rotate with respect to the base body 20. A polygonal hole 33 is provided at the second end 32 and adapted to couple to a bit by dotted shown at 60 in FIG. 1. Teeth 34 are annularly formed on the outer periphery of the first end 31.

The ratchet driving means 40 is placed at the receptacle portion 24 of the base body 20 and includes first and second pawl members 41, 42. The first pawl member 41 includes a pivoted hole 411 pivotally attached to the first pivotal element 26 and teeth 412 formed at an end thereof and engaged with the teeth 34 of the barrel member 30 selectively. An abutted portion 413 and a shifted portion 414 are provided at another end of the first pawl member 41 opposite to the teeth 412. The abutted portion 413 is abutted against one distal end of the projection 253. The shifted portion 414 is abutted against the restricting portion 28 and selectively engaged with the first limited portion 261 by operating the first pawl member 41. The second pawl member 42 includes a pivoted hole 421 pivotally attached to the second pivotal element 27 and teeth 422 formed at an end thereof and engaged with the teeth 34 of the barrel member 30 selectively. An abutted portion 423 and a shifted portion 424 are provided at another end of the second pawl member 42 opposite to the teeth 422. The abutted portion 423 is abutted against another distal end of the projection 253. The shifted portion 424 is abutted against the restricting portion 28 and selectively engaged with the second limited portion 271 by operating the second pawl member 42.

The elastic section 253 is provided between the first and second pawl members 41, 42. The first and second resilient ends 254, 255 respectively press the abutted portions 413, 423 of the first and second pawl members 41, 42 elastically and further cause the teeth 412, 422 of the first and second pawl members 41, 42 to rotate in opposite directions with respect to each other and engage with the teeth 34 of the barrel member 30.

The switch means 50 is pivotally connected to the second end 22 of the base body 20 and restricts the barrel member 30 and the ratchet driving means 40 between the base body 20 and the switch means 50. A through-hole 51 is defined at the center of the switch means 50 and inserted by the second end 32 of the barrel member 30. A projecting portion 52, which is provided in the inner periphery of the switch means 50 and related to the restricting portion 28 of the base body 20, extends toward the first and second pawl members 41, 42 so that while the switch means 50 is driven to rotate with respect to the base body 20, the projecting portion 52 is able to press one of the shifted portions 414, 424 for detaching the related one of the teeth 412, 422 from the teeth 34 of the barrel member 30. Hence, a rotary direction of the barrel member 30 has been switched.

A received hole 521 is axially formed on the projecting portion 52 toward the restricting portion 28 and receives a spring-biased unit 53 that consists of a steel ball 531 and a spring 532. The steel ball 531 is positioned between the restricting portion 28 and the spring 532; therefore, the spring 532 is adapted for positioning the steel ball 531 in the first, second or third recesses 281, 282 or 283 selectively. An annular groove 54 is defined on the inner periphery of the switch means 50 opposite to the projecting portion 52, and a clip 55 is disposed in the annular groove 54 and abutted against the flange 251 of the projection 25 for preventing the switch means 50 detaching from the base body 20.

The switch means 50 is movable between first, second and third positions by positioning the steel ball 531 in the first, second and third recesses 281, 282, 283. While the switch means 50 is in the first position, the steel ball 531 is in the first recess and the teeth 412, 422 of the first and second pawl members 41, 422 are both engaged with the teeth 34 of the barrel member 30. As the base body 20 is driven to rotate clockwise, the second pawl member 42 is engaged with the teeth 34 so that the barrel member 30 is driven to rotate simultaneously. As the base body 20 is driven to rotate counterclockwise, the first pawl member 41 is engaged with the teeth 34 so that the barrel member 30 is driven to rotate simultaneously. Thus, while the switch means 50 is in the first position, the base body 20 is able to drive the barrel member 30 to rotate together whether the base body 20 is driven to rotate clockwise or counterclockwise.

While the switch means 50 is in the second position, the steel ball 531 is positioned in the second recess 282 and the projecting portion 52 presses the shifted portion 414 of the first pawl member 41 as to detach the teeth 412 from the teeth 34 of the barrel member 30. In the same time, the shifted portion 414 is restricted between the projecting portion 52 and the first limited portion 261, and the second resilient end 255 of the elastic section 253 presses the abutted portion 423 of the second pawl member 42 and pivot the second pawl member 42 so that the teeth 422 of the second pawl member 42 is driven to engage with the teeth 34. When the base body 20 is driven to rotate clockwise as to rotate the first and second pawl members 41, 42 clockwise, the first pawl member 41 is restricted not to engage with the teeth 34 and the second pawl member 42 is driven to engage the teeth 34; thus, the barrel member 30 is driven to rotate clockwise. When the base body 20 is driven to rotate counterclockwise and the first and second pawl member 41, 42 are going to rotate with the base body 20. However, the first pawl member 41 is restricted not to engage with the teeth 34 and the second pawl member 42 is driven to skip tooth on the teeth 34 so that the barrel member 30 can not be driven to rotate with the base body 20.

While the switch means 50 is in the third position, the steel ball 531 is positioned in the third recess 283 and the projecting portion 52 presses the shifted portion 424 of the second pawl member 42 as to detach the teeth 422 from the teeth 34 of the barrel member 30. In the same time, the shifted portion 424 is restricted between the projecting portion 52 and the second limited portion 271, and the first resilient end 254 of the elastic section 253 presses the abutted portion 413 of the first pawl member 41 and pivot the first pawl member 41 so that the teeth 412 of the first pawl member 41 is driven to engage with the teeth 34. When the base body 20 is driven to rotate counterclockwise as to rotate the first and second pawl members 41, 42 clockwise, the second pawl member 42 is restricted not to engage with the teeth 34 and the first pawl member 41 is driven to engage the teeth 34; thus, the barrel member 30 is driven to rotate counterclockwise. When the base body 20 is driven to rotate clockwise and the first and second pawl member 41, 42 are going to rotate with the base body 20. However, the second pawl member 42 is restricted not to engage with the teeth 34 and the first pawl member 41 is driven to skip tooth on the teeth 34 so that the barrel member 30 can not be driven to rotate with the base body 20.

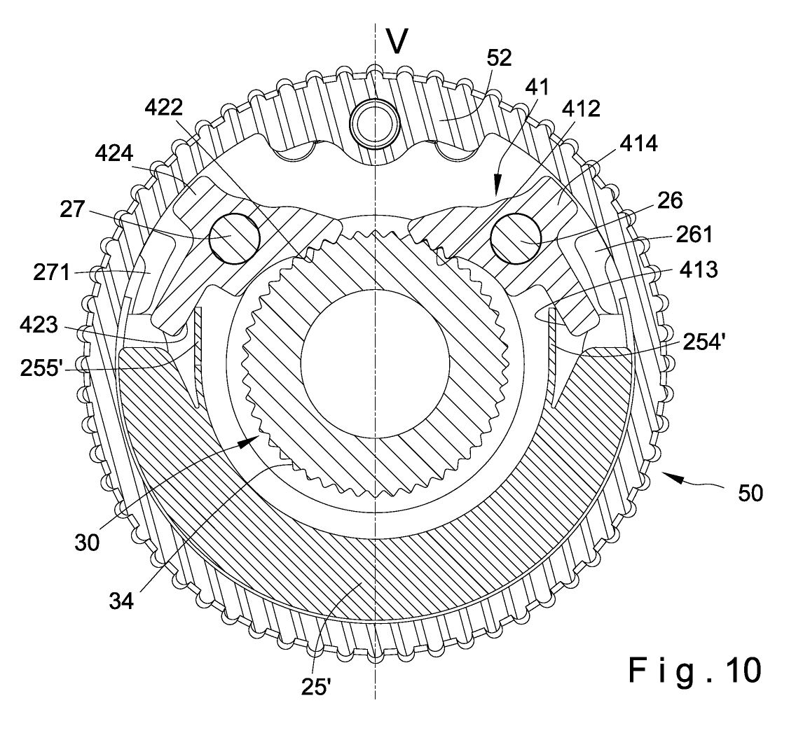

Referring to FIG. 10, it shows a ratchet tool in accordance with a second embodiment of the present invention similar to the first embodiment except that a projection 25′ replaces the projection 25. An arcuate projection 25′ is provided on a side of the receptacle portion 24. A fictitious dotted or dashed line V as shown in FIG. 10 is provided to divide the projection 25′ into two symmetrical parts in accordance therewith. The projection 25 includes a flange 251′ toward the first end 21 of the base body 20 and an elastic section 253′ partially and integrally formed at the inner periphery thereof against the second end 22 of the base body 20. The elastic section 253′ has a U-shaped cross-section and has first and second resilient ends 254′, 255′ defined at two ends of the elastic section 253′. The first and second resilient ends 254′, 255′ are separated from the projection 25′ respectively. The first and second resilient ends 254′, 255′ respectively press the abutted portions 413, 423 of the first and second pawl members 41, 42 elastically and further cause the teeth 412, 422 of the first and second pawl members 41, 42 to rotate in opposite directions with respect to each other and engage with the teeth 34 of the barrel member 30.

While the specific embodiments have been illustrated and described, numerous modifications come to mind without significantly departing from the spirit of invention and the scope of invention is only limited by the scope of accompanying claims.

What is claimed is:

1. A ratchet tool comprising:
a handle;
a base body including a first end coupled to the handle and a second end forming a through-hole axially at the center thereof;
first and second pivotal elements provided at the second end of the base body;
a barrel member coupled to the through-hole of the base body and having teeth formed on the outer periphery thereof;
a restricting portion formed on the second end of the base body opposite to the first end of the base body;
a ratchet driving means including a first pawl member pivotally connected to the first pivotal element and having teeth selectively engaged with the teeth of the barrel member and a second pawl member pivotally connected to the second pivotal element and having teeth selectively engaged with the teeth of the barrel member;
an elastic section provided on the second end of the base body opposite to the restricting portion and between the first and second pawl members, with the elastic section adapted for engaging the teeth of the first and second pawl members with the teeth of the barrel member; and
a switch means pivotally coupled to the outer periphery of the second end of the base body and moveably positioned along the restricting portion for selectively switching the first and second pawl members to engage with the barrel member or not.

2. The ratchet tool as claimed in claim 1 wherein the base body further comprises a through-hole axially formed on and piercing the base body for pivotally coupling to a first end of the barrel member; wherein a second end of the barrel member is inserted through the switch means, with the teeth annularly formed on the outer periphery of the first end; wherein the barrel member further comprises a polygonal hole provided at the second end of the barrel member and adapted to couple to a bit, with the barrel member and the ratchet driving means are restricted between the switch means and the base body.

3. The ratchet tool as claimed in claim 1 further comprising a projection, which is formed on the periphery of the second end of the base body and has a receiving portion formed at the inner periphery thereof, and abutted portions respectively formed at the first and second pawl members; wherein the elastic section has first and second resilient ends, with parts of the elastic section between the first and second resilient ends of the elastic section corresponding and received in the receiving portion, and with the first and second resilient ends of the elastic section respectively pressing the abutted portions elastically and causing the teeth of the first and second pawl members respectively to rotate in opposite directions with respect to each other and engage with the teeth of the barrel member.

4. The ratchet tool as claimed in claim 3, with the elastic section being in form of a U-shaped flat piece.

5. The ratchet tool as claimed in claim 3, with a dotted line provided to divide the projection into two symmetrical parts in accordance therewith, and with the first and second pawl members set on the second end of the base body opposite to the projection and symmetrical to each other in accordance with the dotted line.

6. The ratchet tool as claimed in claim 3 wherein the first and second pawl members respectively form the abutted portions at an end thereof, and shifted portions are provided at the first and second pawl members opposite to the abutted portions respectively; wherein a projecting portion is provided in the inner periphery of the switch means and related to the restricting portion of the base body for pressing one of the shifted portions of the first and second pawl members for detaching the related one of the teeth of the first and second pawl members from the teeth of the barrel member.

7. The ratchet tool as claimed in claim 6, further comprising a received hole axially formed on the projecting portion toward the restricting portion and a spring-biased unit received in the received hole and consisting of a steel ball and a spring, and with the steel ball positioned between the restricting portion and the spring.

8. The ratchet tool as claimed in claim 7 wherein the restricting portion includes an arcuate rail opposite to the projection and first, second and third recesses formed on the rail and equally spaced from one another, with the first recess intermediating the second and third recesses.

9. The ratchet tool as claimed in claim 8, with the switch means movable between first, second and third positions by positioning the steel ball in the first, second and third recesses.

10. The ratchet tool as claimed in claim 3, further comprising first and second limited portions respectively disposed between the first and second pivotal elements and two distal ends of the projection for selectively restricting the shifted portions of the first and second pawl members respectively.

11. The ratchet tool as claimed in claim 6 further comprising an annular groove defined on the inner periphery of the switch means opposite to the projecting portion, and a clip disposed in the annular groove and abutted against the projection for preventing the switch means detaching from the base body.

12. The ratchet tool as claimed in claim 1 further comprising a projection, which is formed on the periphery of the second end of the base body, abutted portions respectively formed at the first and second pawl members and an elastic section partially and integrally formed at the inner periphery of the projection against the second end of the base body 20; wherein the elastic section has first and second resilient ends separated from the projection respectively, and with the first and second resilient ends of the elastic section respectively pressing the abutted portions elastically and causing the teeth of the first and second pawl members respectively to rotate in opposite directions with respect to each other and engage with the teeth of the barrel member.

13. The ratchet tool as claimed in claim 12, with the elastic section having a U-shaped cross-section.

14. The ratchet tool as claimed in claim 12, with a dotted line provided to divide the projection into two symmetrical parts in accordance therewith, and with the first and second pawl members set on the second end of the base body opposite to the projection and symmetrical to each other in accordance with the dotted line.

15. The ratchet tool as claimed in claim 12 wherein the first and second pawl members respectively form the abutted portions at an end thereof, and shifted portions are provided at the first and second pawl members opposite to the abutted portions respectively; wherein a projecting portion is provided in the inner periphery of the switch means and related to the restricting portion of the base body for pressing one of the shifted portions of the first and second pawl members for detaching the related one of the teeth of the first and second pawl members from the teeth of the barrel member.

16. The ratchet tool as claimed in claim 15, further comprising a received hole axially formed on the projecting portion toward the restricting portion and a spring-biased unit received in the received hole and consisting of a steel ball and a spring, and with the steel ball positioned between the restricting portion and the spring.

17. The ratchet tool as claimed in claim 16 wherein the restricting portion includes an arcuate rail opposite to the projection and first, second and third recesses formed on the rail and equally spaced from one another, with the first recess intermediating the second and third recesses.

18. The ratchet tool as claimed in claim 17, with the switch means movable between first, second and third positions by positioning the steel ball in the first, second and third recesses.

19. The ratchet tool as claimed in claim 12, further comprising first and second limited portions respectively disposed between first and second pivotal elements and two distal ends of the projection for selectively restricting the shifted portions of the first and second pawl members respectively.

20. The ratchet tool as claimed in claim 15 further comprising an annular groove defined on the inner periphery of the switch means opposite to the projecting portion, and a clip disposed in the annular groove and abutted against the projection for preventing the switch means detaching from the base body.
